(19) United States
(12) Patent Application Publication
(10) Pub. No.: US 2003/0024766 A1
(43) Pub. Date: Feb. 6, 2003

(54) Sound moderator for oxygen concentrator

(76) Inventor: Loren Briscoe SR., Grants Pass, OR (US)

Correspondence Address: Loren M. Briscoe, Sr., 384 S. W. Park Street, Grants Pass, OR, 97527, US

(21) Appl. No.: 09/781,064

(22) Filed: Aug. 6, 2001

(51) Int. Cl. G10K 11/04

(52) U.S. Cl. 181/200; 181/198

(57) ABSTRACT

This invention simply quiets down the sound of the operation of the Oxygen Concentrator so the user can sleep.

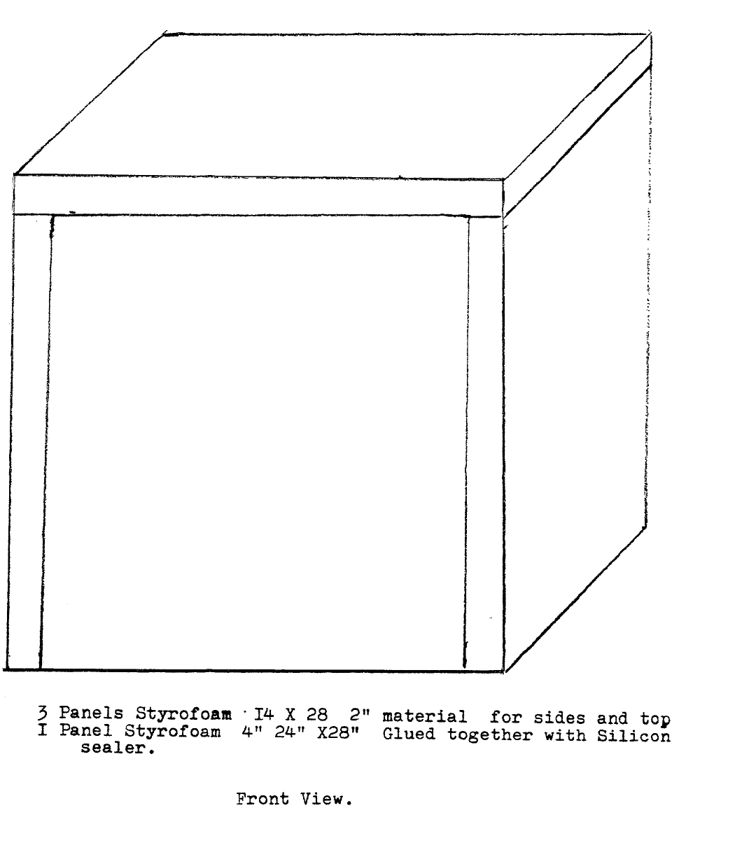

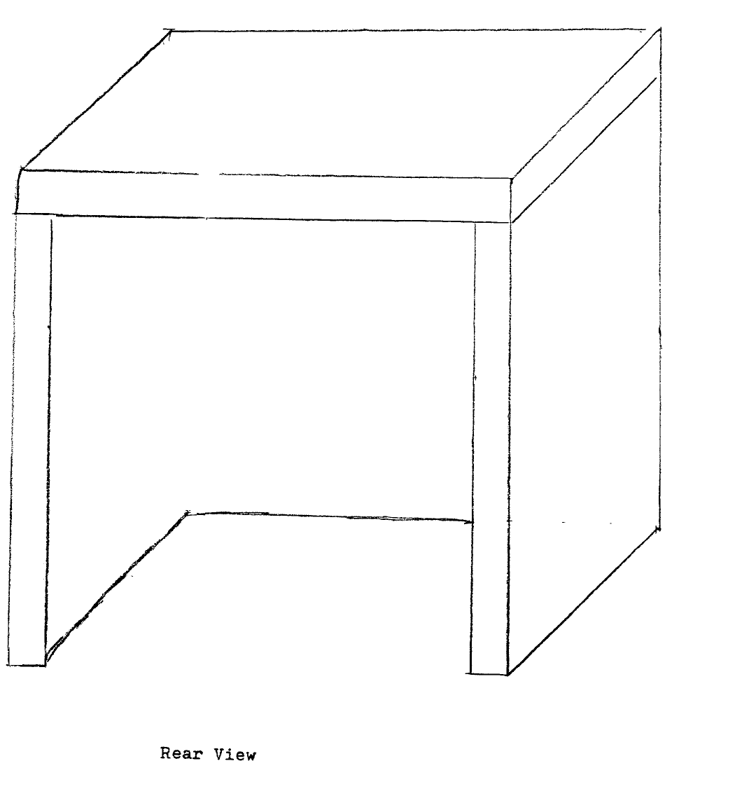

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

On Oct. 19, 2000 my doctor informed me that I was only getting 80% of the oxygen my body required. I was supplied with an oxygen concentrator. This was too noisy to get any sleep. On Nov. 19, 2000, I built my first Sound Moderator for Oxygen Concentrator. It does quiet down the sound of the machine by about 50% which allows me to get some sleep.

### BRIEF DESCRIPTION OF THE SEVERAL VIEWS OF THE DRAWING

It is a rear view of a styrofoam enclosure that surrounds the Oxygen Concentrator—open on the bottom and the back.

It is the front view of a styrofoam disclosure that surrounds the Oxygen Concentrator—open on the back and the bottom.

### DETAILED DESCRIPTION OF THE INVENTION

Enclosure is made of styrofoam—3 panels for the sides and top 14″×28″ (2″ thick). One panel 24″×28″ (4″ thick) for the front glued together with Silicon Sealer. The back and bottom of the enclosure are left open to accomodate the Oxygen Concentrator and give access to the electric socket needed.

What I claim as my invention is:

1. This is a device that quiets the Oxygen Concentrator noise down by about 50%, without hindering the normal operation of the machine. Furthermore, this moderator is especially helpful for a light sleeper.
